(19) United States
(12) Patent Application Publication
(10) Pub. No.: US 2026/0254976 A1
(43) Pub. Date: Aug. 27, 2026

(54) VISION TOKENIZATION FOR AUTONOMOUS DRIVING FOUNDATION MODELS

(71) Applicant: NVIDIA Corporation, Santa Clara, CA (US)

(72) Inventors: Jonathan LORRAINE, Toronto (CA); Seung Wook KIM, Seoul (KR); Jonah PHILION, Toronto (CA); Sanja FIDLER, Toronto (CA); Marco PAVONE, Stanford, CA (US); Yan WANG, Santa Clara, CA (US)

(73) Assignee: NVIDIA Corporation, Santa Clara, CA (US)

(21) Appl. No.: 19/065,756

(22) Filed: Feb. 27, 2025

(51) Int. Cl. H04N 19/30; G06T 7/50; G06V 10/26; G06V 10/82; G06V 20/56; H04N 19/124; H04N 19/172

(52) U.S. Cl. CPC H04N 19/30; G06T 7/50; G06V 10/26; G06V 10/82; G06V 20/588; H04N 19/124; H04N 19/172; G06T 2207/10016; G06T 2207/20084; G06T 2207/30252

(57) ABSTRACT

Various examples, systems, and methods are disclosed relating to an autonomous vehicle pipeline. A first computing system can provide at least one frame of video data, from one or more vehicle sensors, to one or more encoders to generate an encoded representation of the at least one frame. The first computing system further can decode the encoded representation using a plurality of decoders to generate a plurality of tokens to represent the at least one frame. The plurality of decoders can include at least an image decoder, a feature decoder, and a depth decoder. The plurality of decoders and the one or more encoders can be updated according to example video data captured by example vehicle sensors.

### BACKGROUND

Autonomous driving systems often rely on the ability to process high-dimensional video data from multiple vehicle-mounted sensors in real-time (or near real-time). Existing solutions for compressing video data, such as traditional image encoders or vector quantization methods, present challenges in maintaining fidelity and performance in time-critical automotive applications. For example, techniques such as Vector Quantized Variational Autoencoders (VQ-VAE) and Vector Quantized Generative Adversarial Networks (VQ-GAN) offer compression capabilities but are computationally intensive and lack domain-specific optimizations and/or improvements customized for self-driving vehicles. Furthermore, transformer-based video encoding often fails to meet the latency and resource constraints imposed by real-time autonomous driving environments. Additionally, multi-scale encoding methods (e.g., using hierarchical representations) often require architectures that cannot perform efficiently within the limited computational and power budgets of vehicle hardware. These shortcomings prevent current systems from supporting compressed video representations for downstream tasks such as future prediction and trajectory planning.

### SUMMARY

Implementations of the present disclosure relate to systems and methods for vision tokenization in autonomous driving models. The systems and methods described herein address video data compression by implementing a multi-scale video tokenizer that utilizes various combinations of one or more encoders, quantizers, and/or decoders, including for automotive applications. For example, the system can use encoders to generate compressed representations of video streams and incorporate auxiliary losses, such as those related to depth estimation, object segmentation, and/or lane detection, to assist downstream tasks. Additionally, quantization techniques can be applied to discretize encoded representations for efficient and/or improved processing. By leveraging hierarchical encoding and multi-resolution decoding, the system can adjust the number of tokens based on resolution requirements, facilitating real-time operation with minimal and/or reduced computational overhead. Furthermore, causal convolutions and transformer-based compressors can be used to generate target tokens with positional encoding, supporting video processing while maintaining fidelity for autonomous vehicle applications.

Some implementations relate to one or more processors including processing circuitry to provide at least one frame of video data, obtained using sensor data from one or more vehicle sensors, to one or more encoders to generate an encoded representation of the at least one frame. The processing circuitry to decode the encoded representation using a plurality of decoders to generate a plurality of tokens to represent the at least one frame. In some implementations, the plurality of decoders including at least an image decoder, a feature decoder, and a depth decoder. In some implementations, the one or more parameters of plurality of decoders and the one or more encoders are updated according to example video data captured by example vehicle sensors.

In some implementations, the processing circuitry is to update the one or more parameters of the plurality of decoders according to one or more losses associated with at least one of lane detection, object segmentation, or depth estimation. In some implementations, the example video data includes data from a perspective of one or more vehicles operating on one or more roads. In some implementations, the processing circuitry is to provide the encoded representation of the at least one frame to at least one quantizer to discretize the encoded representation to provide to the plurality of decoders.

In some implementations, the processing circuitry is to output a codebook including the plurality of tokens. In some implementations, the one or more encoders include a plurality of layers to perform multi-scale hierarchical encoding. In some implementations, the processing circuitry is to receive the at least one frame as a stream of a plurality of frames of video data, and to use a two-dimensional network to provide image features from the at least one frame and from one or more past frames to the one or more encoders. In some implementations, the processing circuitry includes a transformer compressor between the one or more encoders and the plurality of decoders, the transformer compressor to generate target tokens for positional encoding to provide to the plurality of decoders.

Some implementations relate to a system, including one or more processors to execute operations. The one or more processors to execute operations including operations to encode, using one or more encoders, at least one frame of video data obtained used sensor data from one or more vehicle sensors, to generate an encoded representation of the at least one frame. The one or more operations include operations to decode the encoded representation using a plurality of decoders to generate a plurality of tokens to represent the at least one frame. In some implementations, the plurality of decoders include at least an image decoder, a feature decoder, and a depth decoder. In some implementations, one or more parameters of the plurality of decoders and the one or more encoders are updated according to example video data captured by example vehicle sensors.

In some implementations, the operations include operations to update the one or more parameters of the plurality of decoders according to one or more losses associated with at least one of lane detection, object segmentation, or depth estimation. In some implementations, the example video data includes data from a perspective of one or more vehicles operating on one or more roads. In some implementations, the operations include operations to provide the encoded representation of the at least one frame to at least one quantizer to discretize the encoded representation to provide to the plurality of decoders.

In some implementations, the operations include operations to output a codebook including the plurality of tokens. In some implementations, the one or more encoders include a plurality of layers to perform multi-scale hierarchical encoding. In some implementations, the operations include operations to receive the at least one frame as a stream of a plurality of frames of video data, and at least one operation to use a two-dimensional network to provide image features from the at least one frame and from one or more past frames to the one or more encoders. In some implementations, the one or more processors include a transformer compressor between the one or more encoders and the plurality of decoders, the transformer compressor to generate target tokens for positional encoding to provide to the plurality of decoders.

Some implementations relate to a method. The method includes providing, using one or more processors, at least one frame of video data obtained using sensor data from one or more vehicle sensors, to one or more encoders to generate an encoded representation of the at least one frame. The method includes decoding, using the one or more processors, the encoded representation using a plurality of decoders to generate a plurality of tokens to represent the at least one frame. In some implementations, the plurality of decoders including at least an image decoder, a feature decoder, and a depth decoder. In some implementations, one or more parameters of the plurality of decoders and the one or more encoders updated according to example video data captured by example vehicle sensors.

In some implementations, the method further includes updating, by the one or more processors, the one or more parameters the plurality of decoders according to one or more losses associated with at least one of lane detection, object segmentation, or depth estimation. In some implementations, the example video data includes data from a perspective of one or more vehicles operating on one or more roads.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more vision language models (VLMs), a system for generating synthetic data, a system for generating synthetic data using AI, a system incorporating one or more virtual machines (VMs), a system using or deploying one or more inference microservices, a system that incorporates one or more machine learning models deployed in a service or microservice along with an OS-level virtualization package (e.g., a container), a system implemented at least partially in a data center, and/or a system implemented at least partially using cloud computing resources.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models-that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)-which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples-such as where the model(s) is large-the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### BRIEF DESCRIPTION OF THE DRAWINGS

The present systems and methods for vision tokenization for autonomous driving foundation models are described in detail below with reference to the attached drawing figures, wherein:

FIG. 1 is a block diagram of an example of a system, in accordance with some implementations of the present disclosure;

FIG. 2 is a flow diagram of an example of a method for video data tokenization in an autonomous vehicle pipeline, in accordance with some implementations of the present disclosure;

FIG. 3 is an example illustration of multi-scale video tokenizer architecture, in accordance with some implementations of the present disclosure;

FIG. 4 is a block diagram of a video tokenizer system including encoder(s), quantizer(s), and decoder(s), in accordance with some implementations of the present disclosure;

FIG. 5 is a block diagram of a temporal-based video tokenizer system with a caching mechanism for integrating 2D and 3D features, in accordance with some implementations of the present disclosure;

FIG. 6A is a block diagram of an example generative language model system suitable for use in implementing at least some implementations of the present disclosure;

FIG. 6B is a block diagram of an example generative language model that includes a transformer encoder-decoder suitable for use in implementing at least some implementations of the present disclosure;

FIG. 6C is a block diagram of an example generative language model that includes a decoder-only transformer architecture suitable for use in implementing at least some implementations of the present disclosure;

FIG. 7 is a block diagram of an example computing device suitable for use in implementing at least some implementations of the present disclosure; and

FIG. 8 is a block diagram of an example data center suitable for use in implementing at least some implementations of the present disclosure.

### DETAILED DESCRIPTION

This disclosure relates to systems and methods for tokenization of video data, such as vision tokenization for autonomous driving foundation models. Vehicles, including autonomous (e.g., self-driving) vehicles, can rely on streamed data from various sensors. This can include video data from video sensors and/or cameras. To facilitate autonomous driving foundation models, such as generative models that can operate on video data to perform predictions, perception, and/or planning operations for autonomous vehicle, it can be useful to tokenize, e.g., determine a compressed or encoded representation of, video information captured by video sensors. For example, such use cases can have significant constraints, such as (for example and without limitation): (1) being fast enough for real-world usage; (2) having high enough quality to meet performance tests; and (3) being capable of being operated in resource constrained environments (e.g., with size, weight, computing capacity, and/or power limitations for on-vehicle hardware). As an example, in order to be useful for downstream tasks, video tokenization and/or processing by foundation models can be required to have a pipeline processing time of 100 milliseconds (ms) or less, including, for example, 10 ms or less for tokenization.

Some encoders, such as quantized encoders, vector quantized encoders, and vector quantized generative adversarial networks, have been used to attempt to perform video tokenization. However, such techniques can fail to maintain high fidelity in real-time video applications due to the computational overhead and lack of domain-specific optimizations. Additionally, such techniques result in limited scalability when processing high-dimensional video data in resource-constrained environments. That is, these methods rely on fixed architectures that often fail to dynamically adapt compression and encoding efficiency based on computational or latency constraints, which limits the methods suitability for real-time video processing pipelines in autonomous vehicles.

Systems and methods in accordance with the present disclosure can implement a video tokenization system, e.g., pipeline and/or neural network, capable of performing tokenization with sufficient speed and performance to be implemented for real-time automotive video processing. The system can include one or more encoders, one or more quantizers, and one or more decoders. The encoders can include, for example, video encoders such as DinoV2 and/or VQ-GAN encoders. The decoders can include image decoders, DinoV2 feature decoders, and/or depth decoders. Thus, the systems and methods provide technical improvements in reducing processing latency and improving resource allocation for tokenization. For example, hierarchical encoding techniques partition video data into multiple resolution levels, allowing low-resolution tokens to be prioritized under strict latency requirements while higher-resolution tokens are processed as resources permit. Furthermore, the systems and methods improve multi-stream data handling for applications requiring and/or otherwise using synchronized token outputs by implementing multi-scale encoding with resolution-dependent token generation.

In some implementations, the system implements one or more auxiliary losses for training the tokenizer, such as to provide context-based scoring such as for lane detection, object segmentation, and/or depth estimation. This can allow for improved performance of downstream tasks useful for models updated based on the tokenizer, such as for autonomous movement and/or trajectory planning operations. The system can perform hierarchical encoding, such as to perform encoding at various resolutions or levels of detail of the image information. This can allow the system to dynamically adjust the number of tokens based on desired resolution during decoding. The system can use a two-dimensional (2D) network to detect image features (e.g., compared with a 3D network). The 2D network can provide image features from a given image frame as well as from past frames to a 3D network, allowing for reduced image data to be processed for each frame (e.g., in comparison with full 3D image data processing). In some implementations, the system uses a transformer compressor to process target tokens, such as for positional encoding. For example, the transformer encoder can provide a plurality of tokens together with tokens produced by the one or more encoders to a transformer decoder (e.g., to a quantizer between the encoders and decoders) to facilitate positional encoding.

The systems and methods described herein apply to enhancing real-time (or near real-time) video compression for autonomous vehicles, improving trajectory planning through tokenization, and/or supporting generative video modeling. These methods improve the efficiency of autonomous vehicle data pipelines, supporting performance across diverse operational scenarios.

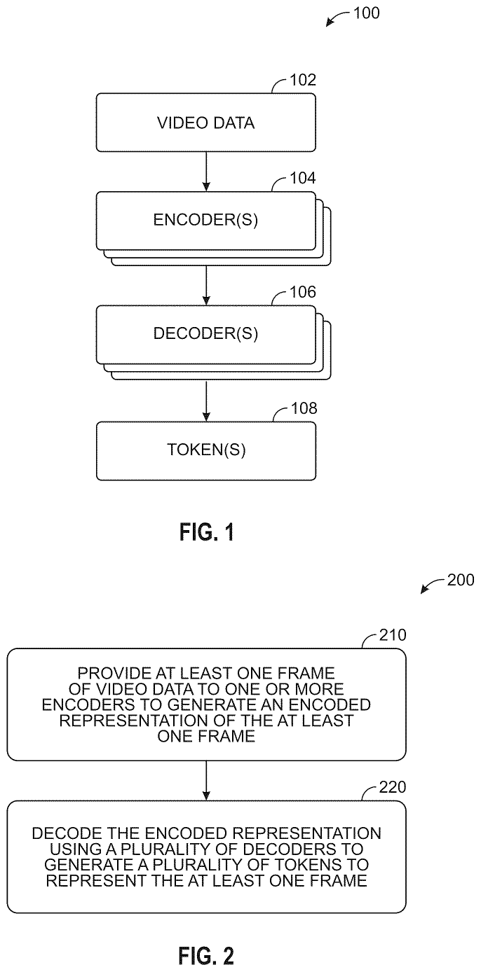

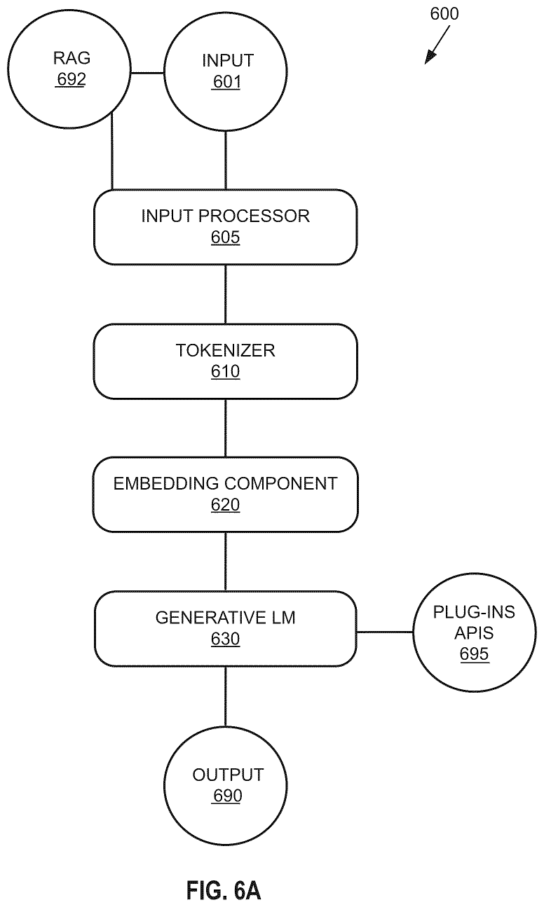

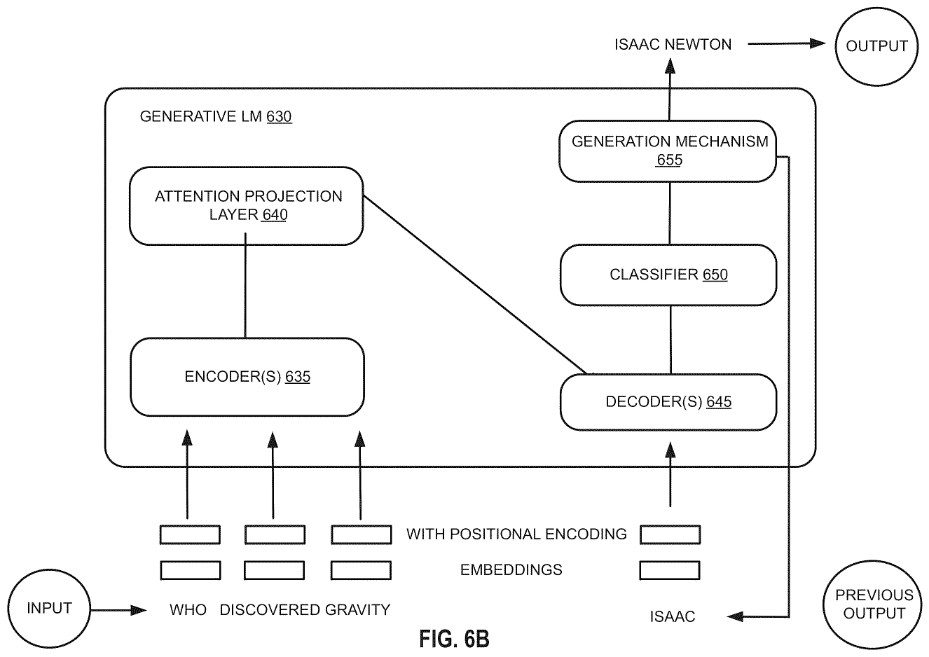

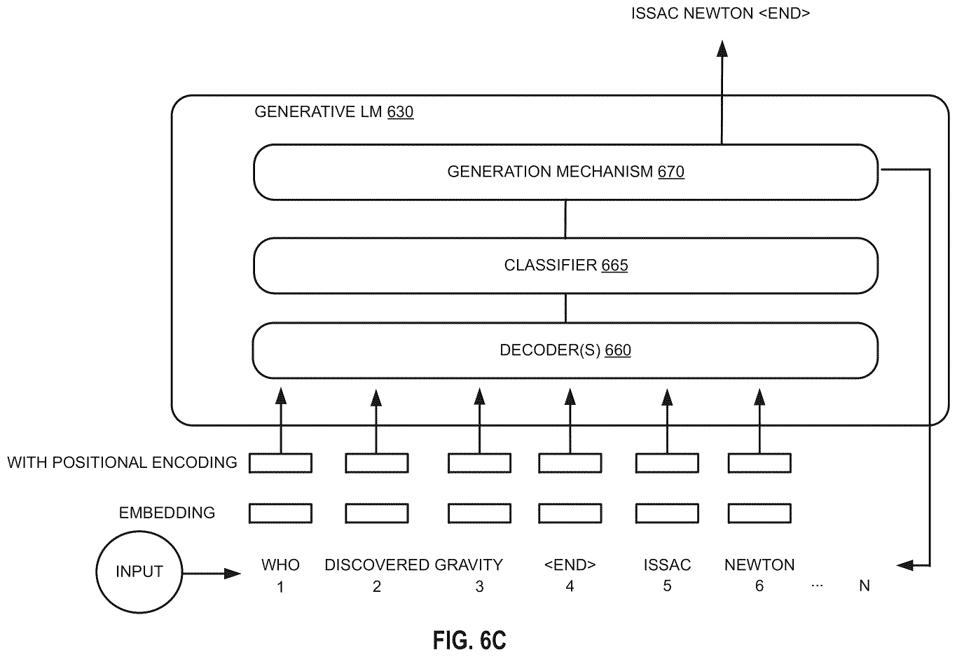

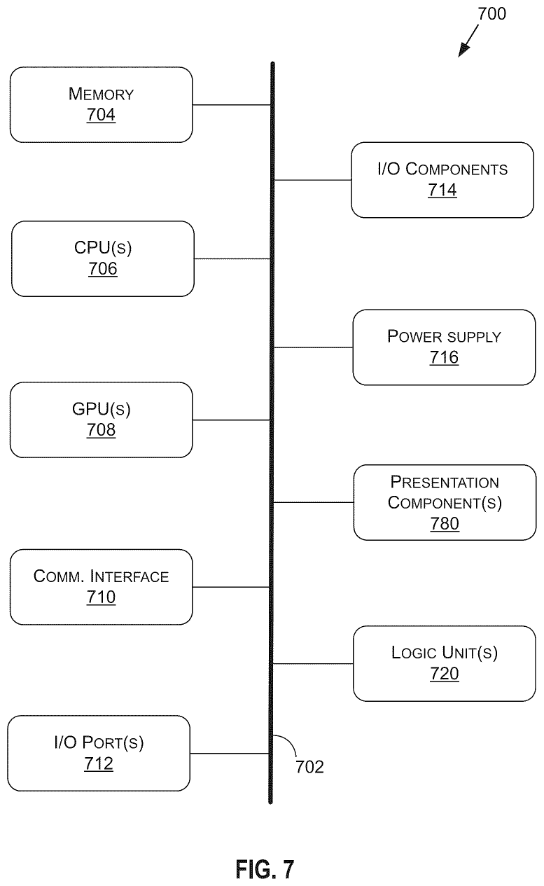

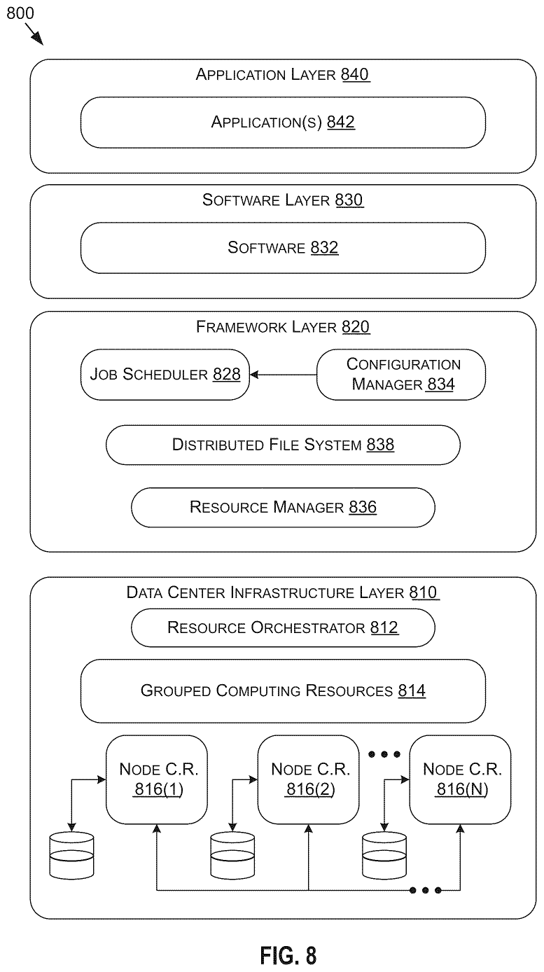

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 600 of FIG. 6A, example generative language model (LM) 630 of FIGS. 6B-6C, example computing device 700 of FIG. 7, and/or example data center 800 of FIG. 8.

The system 100 can implement at least a portion of an autonomous vehicle pipeline, such as a perception pipeline, a prediction pipeline, or a planning pipeline. The system 100 can be used to process video data and/or generate tokenized representations by any of various systems described herein, including but not limited to lane detection systems, object tracking systems, trajectory prediction systems, sensor fusion systems, path planning systems, decision-making systems, and/or control systems.

Generally, the autonomous vehicle pipeline can include operations performed by the system 100. For example, the autonomous vehicle pipeline can include any one or more of an encoding stage, a decoding stage, and/or a tokenizing stage. Each stage of the autonomous vehicle pipeline includes one or more components of the system 100 that perform the functions described herein. In some implementations, one or more of the stages can be performed during the training of AI models. Additionally, one or more of the stages can be performed during the inference phase using the AI models.

The system 100 (e.g., implementing the autonomous vehicle pipeline) can provide at least one frame of video data to one or more encoders to generate an encoded representation of the at least one frame. For example, the video can be obtained and/or otherwise using sensor data (e.g., RGB image data, depth maps, point cloud data, thermal imaging, radar reflections, and/or any vehicle perception data) received from one or more vehicle sensors (e.g., cameras, LiDAR, radar, ultrasonic sensors, thermal cameras, and/or depth sensors). In some implementations, implementing the autonomous vehicle pipeline can include the system 100 decoding the encoded representation using a plurality of decoders to generate a plurality of tokens to represent the at least one frame. That is, the plurality of decoders can include at least an image decoder, a feature decoder, a depth decoder, and/or any decoder configured to extract semantic and/or spatial information. Additionally, one or more parameters (e.g., neural network weights, biases, activation thresholds, loss function coefficients, optimization hyperparameters, and/or any learned model parameters) of the plurality of decoders and the one or more encoders can be updated and/or otherwise trained according to example video data captured by example vehicle sensors. Thus, the tokenization pipeline can improve the efficiency of downstream tasks, such as trajectory prediction, object recognition, and/or situational awareness in autonomous driving systems.

The system 100 can implement a multi-scale video tokenizer using the encoder(s) 104, decoder(s) 106, discretization techniques, and/or auxiliary losses trained on a dataset of driving scenarios (e.g., videos captured from road environments, highway intersections, urban streets, rural roads, tunnels, and/or any unstructured environments). In some implementations, the encoder(s) 104 can include a multi-scale video-based architecture with a KV-cache-able structure to process video streams (e.g., using DinoV2 and/or any transformer-based encoder for encoding features at various resolutions). For example, the encoder(s) 104 can process video frames to extract hierarchical features that capture spatial and temporal information across multiple scales. The decoder(s) 106 can include models for decoding images, depth information, and feature embeddings (e.g., DINOV2-based, semantic embeddings) to reconstruct multiple data modalities. In some implementations, quantization can be performed using Finite Scalar Quantization (FSQ) to reduce data size and maintain important feature information.

In some implementations, the system 100 can use one or more auxiliary losses (e.g., image L2 reconstruction, perceptual loss, adversarial GAN loss, depth estimation loss, DINOV2 loss, and/or trajectory prediction loss) to improve and/or fine-tune the performance of downstream tasks (e.g., lane detection, object tracking, path planning). For example, image L2 reconstruction loss can measure the pixel-wise difference between original and reconstructed frames and the trajectory prediction loss can be used to refine motion estimation. In multi-scale processing, the encoder(s) 104 can generate features at different resolutions, with the decoder(s) 106 configured to process at least one (e.g., each) resolution independently. For example, two or more decoders 106 can reconstruct fine-grained spatial details from high-resolution features and global scene context from low-resolution features. Additionally, causal convolutions and transformers can be used to tokenize the video data and preserve temporal dependencies between frames.

In some implementations, the decoder(s) 106 can be updated according to the one or more auxiliary losses with at least one of lane detection, object segmentation, or depth estimation. For example, the system 100 can determine lane detection loss by comparing predicted lane boundary outputs from the image decoder with ground truth annotations. The system 100 can determine gradients based on the lane detection loss and backpropagate the gradients to update the parameters of the decoder(s) 106 (e.g., image decoder). Additionally, the system 100 can determine depth estimation loss by comparing predicted depth values from the decoder(s) 106 (e.g., depth decoder) with pseudo ground truth depth data. The resulting gradients can be propagated through the decoder(s) 106 to update and/or refine the parameters for depth reconstruction. In multi-scale processing, the system 100 can apply the auxiliary losses to specific resolutions, allowing the decoder(s) 106 to update outputs independently for high-resolution spatial details and low-resolution contextual features. For example, object segmentation loss can be used to guide updates to the decoder(s) 106 (e.g., feature decoder).

In some implementations, updating one or more parameters and/or otherwise training the decoder(s) 106 can include applying one or more auxiliary losses (e.g., lane detection loss, object segmentation loss, depth estimation loss) to modify the parameters of one or more decoder(s) 106. That is, to update and/or otherwise train the decoder(s) 106 can include using the calculated auxiliary losses to adjust internal decoder weights and biases based on task-specific discrepancies. For example, lane detection loss can be calculated by the system 100 as the difference between predicted lane boundaries from the image decoder and ground truth lane annotations, and this loss can be used to update the image decoder. In another example, depth estimation loss can be computed by comparing depth values predicted by the depth decoder to pseudo ground truth depth data, with the loss guiding adjustments to the depth decoder parameters. In this example, the system 100 uses auxiliary losses to update the decoder(s) 106 according to the specific outputs associated with each loss function. Additionally, the auxiliary losses can be used to fine-tune the decoder(s) 106 by adjusting decoder layer weights during backpropagation to minimize loss values. For example, segmentation loss can modify the feature decoder by propagating gradients through convolutional and attention layers (e.g., improving feature extraction and object boundary alignment).

In some implementations, the encoding stage can be the stage in the autonomous vehicle pipeline in which the system 100 can provide at least one frame of the video data 102, obtained using sensor data from one or more vehicle sensors, to the one or more encoders 104 (e.g., DinoV2 encoder, VQ-GAN encoder) to generate an encoded representation of the at least one frame. The system 100 can include at least one encoder 104. The encoder 104 can process the video data 102 to extract hierarchical and/or tokenized feature representations. The video data can be obtained using sensor data of one or more vehicles sensors. For example, the video data 102 can include RGB image frames captured by front-facing cameras, depth maps generated using stereo cameras, and/or point cloud data from LiDAR sensors. In another example, radar sensors can provide velocity and distance measurements for objects detected within the scene, which can be used as auxiliary inputs to the encoder 104 for feature extraction and tokenization. That is, providing the frames to the encoder 104 can include converting raw image data into encoded features using operations such as convolution, attention, and/or pooling. For example, during the encoding stage, the encoder 104 can generate a set of spatial and temporal embeddings for at least one (e.g., each) frame of the video data 102.

In some implementations, the system 100 can provide the frame and/or otherwise transmit the frame to the encoders 104 to generate an encoded representation of the at least one frame. Additionally, the frames and be preprocessed by normalizing pixel values or applying augmentations (e.g., scaling, cropping). The one or more vehicle sensors can be front-facing cameras, rear cameras, side cameras, LiDAR, radar, GPS, ultrasonic sensors, and/or any other data-collecting sensors. That is, the video data 102 can be captured in diverse lighting and weather conditions (e.g., night, rain, fog, natural disasters). For example, the encoder 104 can generate an encoded representation by tokenizing the spatial and semantic features. In some implementations, generating the encoded representation can include the encoder 104 performing hierarchical feature extraction. The encoded representation can be a sequence of tokens. For example, the tokens can represent lane boundaries, vehicles, and road signs. In some implementations, the encoders 104 can include a plurality of layers (e.g., convolutional layers, self-attention layers) to perform multi-scale hierarchical encoding (e.g., extracting features at different spatial resolutions).

Additionally, the video data 102 having at least one frame can be received as a stream of a plurality of frames of the video data 102. That is, the stream can be a continuous and/or sequential sequence of images captured at a predefined frame rate (e.g., 30 frames per second). For example, receiving the stream can include the video data 102 being transmitted from the vehicle sensors to the system 100 in real-time. The sensor data can be multi-modal data collected from various vehicle-mounted sensors (e.g., RGB cameras, infrared cameras, LiDAR, radar, ultrasonic sensors, and/or depth sensors). That is, the sensor data can be used to generate synchronized perception inputs by aligning image frames with auxiliary sensor data (e.g., LiDAR point clouds, radar velocity measurements, and/or depth maps) for encoding and tokenization. In some implementations, a two-dimensional network (e.g., 2D CNN) can be used to provide image features from the at least one frame and from one or more past frames to the encoders 104. That is, the system 100 can utilize 2D feature maps to maintain spatial consistency across frames. For example, the encoders 104 can process the received image features to generate tokenized representations of the video frames.

In some implementations, during the encoding stage, the system 100 can provide the encoded representation of the at least one frame to at least one quantizer to discretize the encoded representation to provide to the plurality of decoders. The quantizer can be a separate sub-system and/or component or a component of the encoder 104 configured and/or otherwise implemented to compress feature representations into a discrete format. For example, a transformer compressor (e.g., a positional encoding transformer) can be used and/or otherwise implemented between the plurality of encoders 104 and the plurality of decoders 106. In this example, the transformer compressor can generate target tokens (e.g., reference tokens) for positional encoding (e.g., spatial and temporal token alignment) to provide to the plurality of decoders.

It should be understood that the quantizer can be a component of the encoder 104 and/or a separate component that processes the encoded features for storage and transmission. That is, discretizing can include mapping continuous-valued feature embeddings into a predefined codebook of discrete tokens. The quantizer can reduce redundancy and preserve information for reconstruction. For example, the system 100 can apply FSQ to compress scalar values or VQ to cluster feature vectors into representative tokens. The discretized encoded representation can be provided as input to the decoders 106, auxiliary loss functions, downstream planners, and/or any data-processing components. Thus, while the quantizer is described herein as a component of the encoder 104, the quantizer can also function as an independent processing system and/or block in the autonomous vehicle pipeline.

The encoder 104 can include any one or more artificial intelligence models (e.g., machine learning models, supervised models, neural network models, deep neural network models), rules, heuristics, algorithms, functions, or various combinations thereof to perform operations including feature extraction, such as processing input video frames to generate tokenized representations. That is, encoder 104 can be a neural network and/or machine-learning (ML) model trained to identify spatial and temporal features from video data. The encoder 104 can include one or more parameters, such as weights, biases, activation functions, and layer normalization factors. The one or more parameters of the encoder 104 can be updated according to example video data captured by example vehicles sensors. In some implementations, the encoder 104 can output hierarchical feature embeddings (e.g., spatial tokens, temporal tokens, semantic embeddings, and/or any depth features). For example, the output can be feature tokens representing lane boundaries and road objects. In another example, the output can be depth tokens corresponding to obstacle distances. In some implementations, the video data 102 can be provided to encoder 104 to perform multi-scale feature encoding and/or quantization.

In some implementations, the encoder 104 can maintain, execute, train, update, and/or otherwise process, refine, or apply one or more artificial intelligence (AI) models during the encoding stage. In some implementations, the AI model(s) can include any type of neural network-based AI model capable of learning hierarchical representations (e.g., convolutional neural networks (CNNs), transformers) to extract meaningful features from video data. For example, the AI model(s) can be trained and/or updated to improve spatial and temporal tokenization, among other encoding tasks. The AI model(s) can be or include a transformer-based model (e.g., a generative pre-trained transformer (GPT) model, a bidirectional encoder representations from transformers (BERT) model). The machine-learning model(s) can be or include a recurrent neural network (RNN) model, in some implementations. The encoder 104 can execute the AI model to generate outputs. The encoder 104 can receive data to provide as input to the AI model(s), which can include video frames, sensor metadata, object labels, and/or any depth maps.

In some implementations, the encoder 104 can execute one or more AI models (e.g., CNN, transformer-based models) by utilizing a distributed training framework to improve the performance of the AI model during the encoding stage. The framework can include implementing techniques such as gradient descent, backpropagation, and distributed training to improve the model parameters using large-scale datasets. The AI model(s) can incorporate mechanisms such as dropout regularization and weight pruning to maintain efficiency and prevent overfitting. For example, during execution, the encoder 104 can partition input data into mini-batches, apply loss functions, and update model parameters iteratively. The AI models can support inference operations that include processing feature vectors, transforming raw input data, and generating probabilistic predictions and/or metrics. The encoder 104 can integrate hardware accelerators such as GPUs or TPUs to handle computational demands, for example when processing high-resolution video streams.

In some implementations, the encoder 104 can train and update AI models (e.g., CNNs, transformers) through the autonomous vehicle pipeline that includes data preprocessing, feature engineering, and hyperparameter tuning. The preprocessing stage can include normalizing datasets, processing missing data, and augmenting inputs for training the AI models. Feature engineering can include dimensionality reduction techniques, such as principal component analysis (PCA) or t-SNE. The AI models can incorporate attention mechanisms, activations, and/or layered architectures to facilitate learning. In some implementations, the encoder 104 can evaluate trained models using performance metrics (e.g., precision, recall, and/or F1 score) and/or any additional benchmarks, to determine readiness for deployment and/or inference operations.

In some implementations, the encoder 104 can include at least one AI model. The AI model can include an input layer, an output layer, and/or one or more intermediate layers, such as hidden layers, which can each have respective nodes. That is, the AI model implemented by the encoder 104 can process hierarchical video features. For example, the input layer can process raw video frames. For example, the output layer can generate tokenized embeddings. For example, the intermediate layers can perform feature extraction and spatial-temporal transformations.

In some implementations, the system 100 can configure (e.g., train, update, fine-tune, apply transfer learning to) the encoder 104 (e.g., AI models) by modifying or updating one or more parameters, such as weights and/or biases, of various nodes of the encoder 104 responsive to evaluating estimated outputs of the encoder 104 (e.g., generated in response to receiving training examples in a training dataset, such as a training dataset including video frames, depth maps, semantic labels). The encoder 104 can be or include various neural network models, including models that can operate on or generate data including but not limited to spatial tokens, temporal embeddings, depth features, and/or various combinations thereof.

In some implementations, the encoder 104 can be configured (e.g., trained, updated, fine-tuned, has transfer learning performed, etc.) based at least on the training data of the at least one training dataset (e.g., video datasets, sensor metadata, ground truth labels). For example, one or more example frames and/or depth maps of the training data can be applied (e.g., by the system 100, or in a pre-training process performed by the system 100 or another system) as input to the encoder 104 to cause the encoder 104 to generate an estimated output. The estimated output can be evaluated and/or compared with ground truth data (or reference data) of the training data that correspond with the one or more example frames and/or depth maps, and the AI model of the encoder 104 can be updated based at least on the computed loss and/or performance metrics. For example, based at least on an output of a reconstruction loss function, one or more parameters (e.g., weights and/or biases) of the AI model of the encoder 104 can be updated.

In some implementations, the decoding stage can be the stage in the autonomous vehicle pipeline in which the system 100 can decode the encoded representation using a plurality of decoders 106 (e.g., image decoder, DinoV2 feature decoder, depth decoder, and/or auxiliary losses) to generate a plurality of tokens (e.g., spatial tokens, semantic tokens). The decoders 106 and/or encoder 104 can include one or more parameters. The system 100 can include at least one decoder 106. The decoder 106 can include at least an image decoder (e.g., responsible for reconstructing the original video frame), a feature decoder (e.g., DinoV2, semantic embeddings for object detection), and a depth decoder (e.g., depth map generation for obstacle detection). In some implementations, the output of a decoder can be a data structure and/or any tokenized feature map that provides reconstructed information. For example, the decoding stage can include outputting a codebook including the plurality of tokens 108. The tokens 108 can be processed to reconstruct spatial features, semantic information, and/or depth data.

In some implementations, the tokens 108 can be generated by applying inverse transformations to the encoded data. That is, the various decoders 106 can output reconstructed modalities that can be merged (e.g., by concatenation and/or attention mechanisms) to create the tokens 108 representing visual scene elements. Concatenation can include the system 100 stacking feature maps and/or token sequences from multiple decoders along a designated dimension (e.g., channel or spatial axis) to form a unified representation. Attention mechanisms can include the system 100 applying self-attention or cross-attention to assign weights to the outputs from different decoders based on relevance to specific scene elements (e.g., objects, road boundaries). For example, the image decoder can output reconstructed frames, the feature decoder can output semantic embeddings, and the depth decoder can output depth maps. In this example, the system 100 can integrate these outputs for further processing (e.g., trajectory planning, obstacle detection, and/or other downstream applications)

In some implementations, the plurality of decoders 106 and the one or more encoders 104 can be updated and/or otherwise trained according to example video data captured by example vehicle sensors. For example, the example video data can include data from a perspective (e.g., front-facing, side-facing, rear-facing) of one or more vehicles operating on one or more roads. The perspective can be any view captured by vehicle-mounted sensors (e.g., cameras, LiDAR, radar) to provide spatial and temporal context for autonomous driving tasks. That is, the one or more parameters of the plurality of decoders 106 can be updated according to one or more losses (e.g., auxiliary losses, adversarial losses, perceptual losses) associated with at least one of lane detection, object segmentation, and/or depth estimation. In the above example, the example video data can include diverse scenarios such as urban environments, highways, rural areas, intersections, and/or parking lots. For example, the auxiliary losses can be determined using the decoders 106 by comparing predicted outputs (e.g., depth maps, semantic masks) to ground truth data.

Additionally, the plurality of encoders 104 can be updated (e.g., one or more parameters can be updated) according to feature extraction losses (e.g., reconstruction loss, contrastive loss) associated with tokenization accuracy, temporal consistency, and/or spatial fidelity. That is, providing the frames to the encoder 104 can include preprocessing operations such as normalization, resizing, and/or cropping. For example, during the encoding stage, the encoder 104 can tokenize the frames to generate hierarchical embeddings. In some implementations, the system 100 can provide the frame and/or otherwise process it by applying data augmentation techniques (e.g., flipping, rotating, scaling). The one or more vehicle sensors can be front-facing cameras, side cameras, rear cameras, LiDAR, radar, GPS, ultrasonic sensors, and/or any additional sensors capturing environmental data. That is, the video data 102 can be collected under various lighting, weather, and/or traffic conditions. For example, the encoder 104 can generate an encoded representation by extracting multi-scale spatial and temporal features from the input frames. In some implementations, generating the encoded representation can include the encoder 104 performing operations such as convolution, self-attention, and/or pooling. The encoded representation can be a sequence of tokens representing hierarchical feature maps. For example, these tokens can correspond to road boundaries, dynamic objects, and/or static infrastructure elements.

The decoder 106 can include any one or more artificial intelligence models (e.g., machine learning models, supervised models, neural network models, deep neural network models), rules, heuristics, algorithms, functions, or various combinations thereof to perform operations including feature reconstruction, such as feature decoding, image reconstruction, depth estimation, and/or any modality-specific reconstruction tasks. That is, the decoder(s) 106 can be a plurality of neural networks and/or machine-learning (ML) models trained to reconstruct spatial features, predict depth maps, process semantic embeddings, and/or transform quantized data into actionable outputs. In some implementations, the decoder 106 can output reconstructed frames (e.g., video frames, depth maps, semantic features, and/or any other tokenized outputs). For example, the output can be reconstructed images representing road surfaces and objects. In another example, the output can be depth maps that identify obstacle distances. In some implementations, the encoded data (e.g., quantized) from the encoder 104 can be provided to decoder 106 to perform inverse feature transformation.

In some implementations, the decoder 106 can maintain, execute, train, update, and/or otherwise process, refine, or apply one or more artificial intelligence (AI) models during the decoding stage. In some implementations, the AI model(s) can include any type of feedforward AI model capable of reconstructing hierarchical features (e.g., convolutional autoencoders, transformer-based decoders) to produce refined outputs. For example, the AI model(s) can be trained and/or updated to enhance spatial resolution, improve depth accuracy, and refine semantic segmentation, among other decoding tasks. The AI model(s) can be or include a transformer-based model (e.g., a generative pre-trained transformer (GPT) model, a bidirectional encoder representations from transformers (BERT)). The machine-learning model(s) can be or include a variational autoencoder (VAE) model, in some implementations. The decoder 106 can execute the AI model to generate outputs. The decoder 106 can receive data to provide as input to the AI model(s), which can include quantized tokens, positional embeddings, feature vectors, and/or any latent representations.

In some implementations, the decoder 106 can execute one or more AI models (e.g., image model, feature model, depth model) by utilizing a distributed training framework to improve the performance of the AI model during the decoding stage. The framework can include implementing techniques such as gradient descent, backpropagation, and distributed training to handle large-scale datasets. The AI model(s) can incorporate mechanisms such as L2 regularization and weight pruning to maintain efficiency and prevent overfitting. For example, during execution, the decoder 106 can partition input data into mini-batches, apply loss functions (e.g., mean squared error, cross-entropy), and/or update model parameters iteratively. The AI models can support inference operations that include processing reconstructed features, refining raw input data, and generating probabilistic outputs and/or structured data. The decoder 106 can integrate hardware accelerators such as GPUs or TPUs to handle computational demands, for example when processing high-resolution video reconstructions.

In some implementations, the decoder 106 can include at least one AI model (e.g., depth decoder, image decoder, feature decoder). The depth decoder can include an input layer, an output layer, and/or one or more intermediate layers, such as hidden layers, which can each have respective nodes. That is, the depth decoder can transform tokenized depth features into pixel-based depth maps. For example, the input layer can process quantized depth tokens. For example, the output layer can generate refined depth maps representing distances to objects. For example, the intermediate layers can apply operations, such as deconvolution and upsampling.

The image decoder can include an input layer, an output layer, and/or one or more intermediate layers, such as hidden layers, which can each have respective nodes. That is, the image decoder can reconstruct high-resolution video frames from compressed tokens. Additionally, the input layer can process spatial embeddings. For example, the output layer can generate reconstructed frames. For example, the intermediate layers can apply non-linear transformations and feature blending.

The feature decoder can include an input layer, an output layer, and/or one or more intermediate layers, such as hidden layers, which can each have respective nodes. That is, the feature decoder can refine semantic features for downstream tasks. For example, the input layer can process semantic embeddings. For example, the output layer can output refined token sequences. For example, the intermediate layers can perform operations such as attention weighting and feature aggregation.

In some implementations, the various decoders can include a hierarchical architecture including an input processing layer, a feature transformation layer, and/or an output generation layer. Each layer can include a plurality of nodes or subcomponents configured to perform specific computations. That is, the various decoders can process input data by propagating it through the layers. For example, the input processing layer can normalize raw input data or extract initial embeddings. For example, the feature transformation layer can apply non-linear transformations or perform dimensionality reduction using operations such as matrix multiplication and activation functions. For example, the output generation layer can generate classification scores, regression outputs, or other inferential results based on the processed data.

In some implementations, the system 100 can configure (e.g., train, update, fine-tune, apply transfer learning to) the decoder(s) 106 by modifying or updating one or more parameters, such as weights and/or biases, of various nodes of the decoder(s) 106 responsive to evaluating estimated outputs of the model (e.g., generated in response to receiving training examples in a training dataset, such as a training dataset including segmentation masks, pseudo ground truth depth data, and/or feature maps). The decoder(s) 106 can be or include various neural network models, including models that can operate on or generate data including but not limited to reconstructed images, refined depth maps, semantic feature embeddings, and/or various combinations thereof.

In some implementations, the decoder(s) 106 can be configured (e.g., trained, updated, fine-tuned, has transfer learning performed, etc.) based at least on the training data of the at least one training dataset (e.g., segmentation mask of a segment anything model (SAM), pseudo ground truth depth data of a depth anything model, object detection annotations). For example, one or more example frames and/or depth maps of the training data can be applied (e.g., by the system 100, or in a pre-training process performed by the system 100 or another system) as input to the decoder(s) 106 to cause the decoder(s) 106 to generate an estimated output. The estimated output can be evaluated and/or compared with ground truth data (or reference data) of the training data that correspond with the one or more example frames and/or depth maps, and the AI model(s) of the decoder(s) 106 can be updated based at least on the computed loss and/or performance metrics. For example, based at least on an output of a reconstruction loss function, one or more parameters (e.g., weights and/or biases) of the AI model(s) of the decoder(s) 106 can be updated.

With reference to FIG. 2, an example flow diagram illustrating a method for video data tokenization in an autonomous vehicle pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 6A-6C), one or more computing devices or components thereof (e.g., as described in FIG. 7), and/or one or more data centers or components thereof (e.g., as described in FIG. 8).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for providing, encoding, quantizing, and/or decoding, operations, in accordance with some implementations of the present disclosure. Various operations of method 200 can relate to improving the efficiency and accuracy of video data processing in autonomous vehicle pipelines. Existing systems often rely on and/or use traditional compression techniques, which can lead to high latency and loss of spatial and temporal details. The existing technological problems can arise when these systems fail to process high-dimensional video data within real-time (or near real-time) constraints, resulting in degraded downstream task performance, such as obstacle detection and trajectory planning. Method 200 of FIG. 2 can solve these technological problems by implementing multi-scale tokenization, hierarchical encoding, and/or auxiliary loss functions, thereby improving real-time video data processing and facilitating accurate autonomous operations.

The method 200, at block 210, includes providing at least one frame of video data, obtained using sensor data from one or more vehicle sensors, to one or more encoders (e.g., DinoV2, VQ-GAN) to generate an encoded representation of the at least one frame. That is, the processing circuits can perform encoding to generate an encoded representation (e.g., spatial features, temporal embeddings) of at least one frame. For example, the processing circuits can encode, using one or more encoders, at least one frame of video data, from one or more vehicle sensors, to generate an encoded representation (e.g., tokenized embeddings) of the at least one frame. The sensor data can be image data, depth maps, LiDAR point clouds, radar signals, and/or any other environmental perception data. The sensors can capture raw multimodal data from the surroundings of the vehicle, including visual information, distance measurements, velocity estimations, and/or object detection inputs for autonomous processing. In some implementations, the processing circuits can provide the encoded representation of the at least one frame to at least one quantizer (e.g., FSQ, LFQ, VQ) to discretize the encoded representation to provide to the plurality of decoders. That is, discretizing can include the processing circuits transforming continuous feature values into discrete token indices for downstream processing.

In some implementations, the encoder can include a plurality of layers (e.g., convolutional layers, attention layers, pooling layers) to perform multi-scale hierarchical encoding. Additionally, the processing circuits can receive at least one frame as a stream of a plurality of frames of video data. In some implementations, the processing circuits can use a two-dimensional network to provide image features (e.g., spatial embeddings) from the at least one frame and from one or more past frames to the one or more encoders. In some implementations, a transformer compressor implemented by the processing circuits can be logically between (e.g., positioned between) the plurality of encoders and the plurality of decoders. That is, the transformer compressor can be used to generate target tokens for positional encoding to provide to the plurality of decoders. For example, the transformer compressor can align spatial and temporal features to verify accurate tokenized representations.

The method 200, at block 220, includes decoding the encoded representation to generate a plurality of tokens to represent the at least one frame. That is, decoding can be performed using a plurality of decoders. For example, the plurality of decoders can include at least an image decoder, a feature decoder, and/or a depth decoder. In some implementations, the one or more parameters of the plurality of decoders and the one or more encoders are updated and/or otherwise trained according to example video data captured by example vehicle sensors. For example, the example video data can include data from a perspective of one or more vehicles operating on one or more roads. That is, the example video data can represent urban streets, highways, rural roads, and/or intersections as perceived by vehicle-mounted sensors. The example video data can include visual features of lane markings, road boundaries, traffic signs, other vehicles, and/or environmental obstacles detected during autonomous and/or semi-autonomous navigation. In this example, the perspective can be a front-facing view, side-view, rear-view, and/or top-down view captured by vehicle-mounted sensors (e.g., cameras, LiDAR, radar, or ultrasonic sensors) to provide spatial and temporal information. Additionally, the processing circuits can update the plurality of decoders according to one or more losses (e.g., auxiliary) associated with at least one of lane detection (e.g., boundary detection, lane marker segmentation), object segmentation (e.g., vehicle segmentation, pedestrian detection), or depth estimation (e.g., disparity maps, obstacle proximity). In some implementations, the processing circuits can output a codebook (e.g., a data structure and/or collection of quantized token indices) including a plurality of tokens (e.g., spatial tokens, temporal tokens, semantic embeddings). That is, the codebook can be a collection, aggregation, reference table, and/or lookup structure of the outputs of the various decoders. For example, the processing circuits can obtain the outputs from the decoders and in turn, prepare them for trajectory prediction or obstacle avoidance tasks.

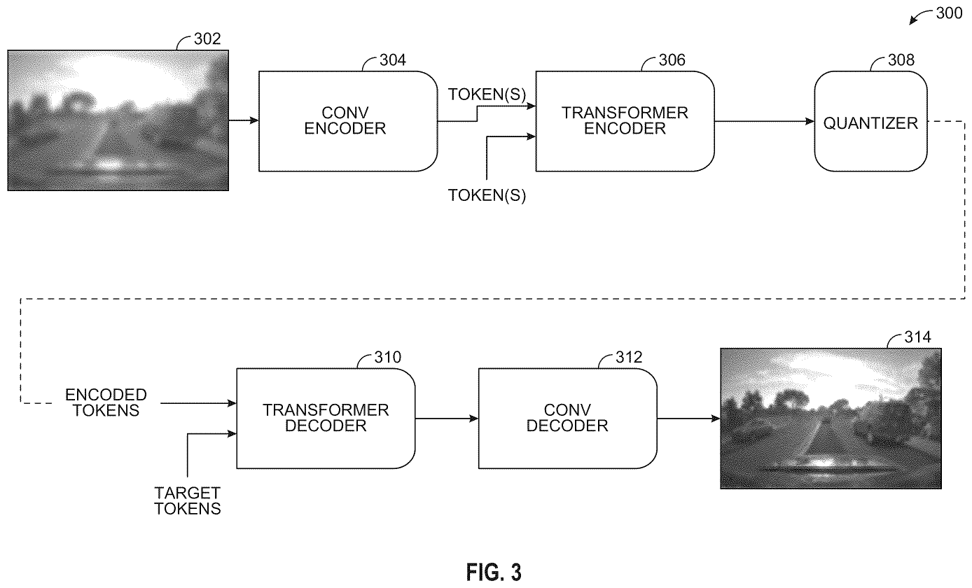

Referring now to FIG. 3, an example illustration of multi-scale video tokenizer architecture 300, in accordance with some implementations of the present disclosure. At block 302, the system 100 can receive video data (e.g., the video data 102) from one or more vehicle-mounted sensors (e.g., front-facing cameras, side cameras, rear cameras, LiDAR, radar, and/or ultrasonic sensors). In some implementations, the video data can be provided in a format suitable for further processing (e.g., RGB frames, grayscale frames, depth maps). That is, the sensors can transmit the video data to the autonomous vehicle pipeline for analysis. For example, a front-facing camera can capture a 160×256 resolution frame at a predetermined frame rate (e.g., 30 frames per second). Additionally, the system 100 can include sub-systems and/or processing circuitry for synchronizing the data stream with other sensor inputs (e.g., LiDAR point clouds and/or GPS data) to align the captured frames temporally.

At block 304, the system 100 can process the received video data using a convolutional encoder (e.g., the encoder(s) 104) to extract spatial features (e.g., edges, textures, and/or regions of interest). In some implementations, the convolutional encoder can convert the input frames into feature maps of lower resolution and reduced dimensionality for computational efficiency. That is, the encoder can apply operations such as convolution, pooling, and/or activation functions to output feature maps representing the structural components of the input. For example, a 160×256 video frame can be encoded into a 20×32 feature map using a combination of stride-based convolutions and max-pooling layers. In this example, the feature map can include spatial elements such as lane markers and object outlines.

At block 304, the system 100 can process the received video data using a convolutional encoder (e.g., the encoder(s) 104) to generate a grid of tokens with spatial dimensions (e.g., dimensions 20×32, resulting in a total of 640 tokens). In some implementations, the convolutional encoder can apply operations such as convolution and pooling to reduce the resolution of the input while preserving spatial information in the form of tokens. That is, at least one (e.g., each) token in the grid can correspond to a region of the input data, capturing spatial features such as edges, textures, corners, gradients, and/or any distinct visual patterns. For example, a 160×256 input frame can be encoded into a 20×32 token grid, with at least one (e.g., each) token representing localized spatial data (e.g., boundary edges, road surfaces, and/or vehicle outlines). In this example, the tokens can be used as input to a transformer encoder for further processing.

At block 306, the system 100 can process the tokens from the convolutional encoder and target tokens (e.g., 160 tokens containing positional encodings) using a transformer encoder to generate refined tokenized outputs. In some implementations, the transformer encoder can analyze spatial relationships and incorporate positional encoding to enhance the representation of the data. That is, the target tokens can be used as references to maintain spatial coherence within the operations of the transformer. For example, the transformer encoder can use self-attention mechanisms to determine dependencies between the input tokens (e.g., 640 tokens) and corresponding target tokens. In this example, the refined output tokens can be prepared for compression by a quantizer.

At block 308, the system 100 can apply a quantizer (e.g., a component of the encoder(s) 104 and/or a separate component) to the refined tokenized data to output a compressed representation. In some implementations, the quantizer processes the target tokens, which are selected from a group of tokens based on positional encoding (e.g., target region of interest). That is, the quantizer discretizes these tokens into a predefined codebook, reducing data size and preserving some information. For example, the quantizer can convert 160 tokens into indices for storage and transmission. In this example, the compression allows the system 100 to improve data handling in resource-constrained environments.

At block 310, the system 100 can process the encoded tokens (e.g., 160 encode tokens) and target tokens (e.g., 640 target tokens of positional encodings) using a transformer decoder (e.g., decoder(s) 106) to generate reconstructed tokens. In some implementations, the transformer decoder can align the encoded tokens with the target tokens by using self-attention and cross-attention mechanisms. That is, the encoded tokens can contain compressed feature representations and the 640 target tokens can maintain spatial positional context. For example, the transformer decoder can distribute the encoded information across the target tokens to reconstruct spatial relationships within the data. In this example, the reconstructed tokens (e.g., the token(s) 108) can provide a grid of 20×32, preserving the spatial structure of the original data (e.g., the video data 102).

At block 312, the system 100 can process the reconstructed tokens (e.g., the token(s) 108) from the transformer decoder using a convolutional decoder (e.g., decoder(s) 106) to generate an output image. In some implementations, the convolutional decoder can upscale the grid of tokens (e.g., 20×32) to match the original resolution of the input video frame (e.g., 160×256). That is, the decoder can apply upsampling operations (e.g., transposed convolutions, interpolation, and/or nearest-neighbor scaling) to output a high-resolution representation of the original frame. For example, the target tokens can be mapped back to a full-resolution frame with spatial details (e.g., fine-grained), such as road markings, vehicle outlines, lane boundaries, traffic signs, pedestrian paths, and/or any contextual environmental features. In this example, the convolutional decoder can refine the token data to output an accurate image for further processing.

At block 314, the system 100 can output the reconstructed video frame for use in perception and decision-making systems within the autonomous vehicle pipeline. In some implementations, the reconstructed frame can be used as input for object detection, semantic segmentation, and/or other downstream computational tasks. That is, the output frame can retain detail and structure to support functions such as identifying lane boundaries, detecting obstacles, planning a trajectory, determining drivable regions, navigating intersections, and/or any collision avoidance computations. For example, a reconstructed frame can be passed to a perception system to identify pedestrians and vehicles.

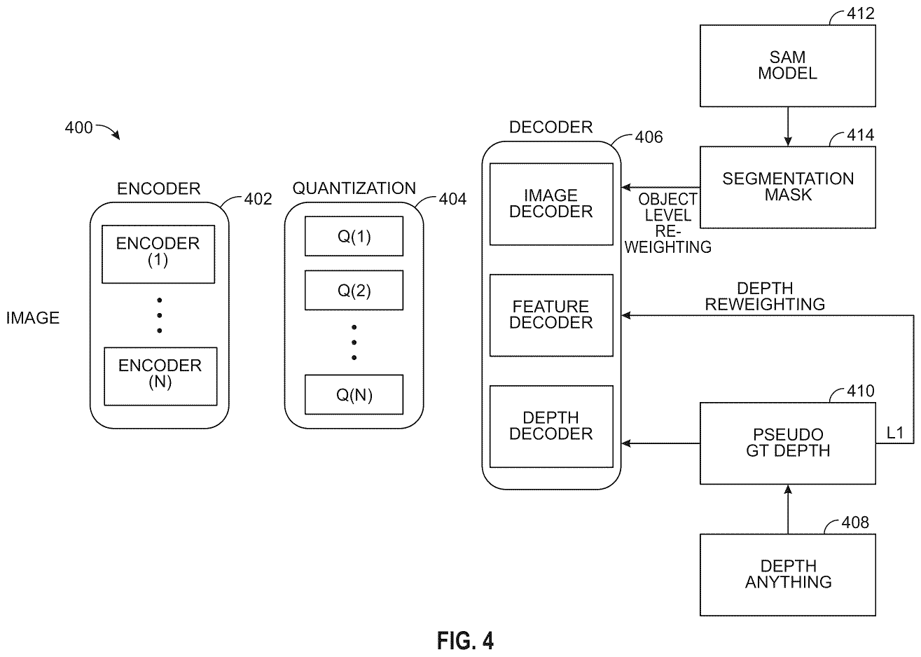

Referring now to FIG. 4, a block diagram of a video tokenizer system 400 including encoder(s), quantizer(s), and decoder(s), in accordance with some implementations of the present disclosure. At block 402, the video tokenizer system 400 (including similar features and functionalities as system 100) can implement an encoder (e.g., CNN-based, Vision Transformer (ViT)-based, and/or DINOV2-based) to process input image data and extract tokenized feature embeddings. In some implementations, the encoder can apply convolutional and/or self-attention mechanisms to capture spatial and semantic features from the input (e.g., edges, textures, object boundaries). That is, the encoder can output feature embeddings suitable for quantization. For example, a CNN encoder can process an input image into hierarchical feature maps, a ViT encoder can output patch embeddings, and a DINOV2-based encoder can generate embeddings for downstream tasks (e.g., depth estimation and/or semantic segmentation).

At block 404, the video tokenizer system 400 can perform quantization using one or more quantizers, such as finite scalar quantization (FSQ), learned feature quantization (LFQ), and/or vector quantization (VQ). In some implementations, the quantizer can discretize the feature embeddings produced by the encoder into a predefined codebook (e.g., scalar levels for FSQ, cluster centers for VQ, and/or learned representations for LFQ) to reduce data size, maintain various information, and/or improve processing efficiency. That is, FSQ can map scalar values, LFQ can apply learned transformations, and VQ can cluster high-dimensional features into tokens. For example, FSQ can be used for lightweight compression in resource-constrained environments and VQ can optimize compression for tasks requiring high fidelity. In this example, the quantized outputs can be provided to the decoders at block 406 for reconstruction of different modalities.

At block 406, the video tokenizer system 400 can use multiple decoders (e.g., image decoder, feature decoder, and depth decoder) to reconstruct various data modalities from the quantized embeddings. In some implementations, the image decoder reconstructs video frames, the feature decoder processes DINOV2 embeddings, and the depth decoder outputs depth maps. That is, at least one (e.g., each) decoder can interpret quantized data (e.g., spatial embeddings, semantic embeddings, depth tokens) for a respective task. For example, the depth decoder can generate a depth map for obstacle detection. In another example, the image decoder can reconstruct the original video frame. In yet another example, the feature decoder can generate semantic feature representations for object segmentation. In this example, auxiliary losses can be applied to improve reconstruction fidelity. That is, auxiliary losses can be applied by using additional training signals (e.g., perceptual loss, L1 loss, and/or adversarial loss).

At block 408, the video tokenizer system 400 can use a depth estimation system (e.g., a Depth Anything model) to generate pseudo ground truth (GT) depth data. In some implementations, this depth data can be used in reweighting the loss functions of the depth decoder. The depth data can be generated from input images, synthetic datasets, LiDAR outputs, 3D point clouds, and/or any other depth-related inputs. That is, depth data can be generated by applying pre-trained depth estimation models. Additionally, at block 410, the video tokenizer system 400 can use the pseudo GT depth as a reference for depth-level reweighting and/or feature alignment. For example, the pseudo GT depth can be used to guide (e.g., adjust weights for) the depth decoder in generating increasingly accurate outputs. In another example, the pseudo GT depth can be used to guide (e.g., align features in) the feature decoder in depth-related segmentation tasks. In some implementations, the video tokenizer system 400 can use the pseudo GT depth (e.g., generated from block 408) to compute auxiliary losses (e.g., L1 loss) for depth reweighting. In some implementations, this process can be used to improve the performance of the depth decoder by fine-tuning the output depth maps. That is, the auxiliary loss can be used to verify consistency between the reconstructed depth and the pseudo GT depth. For example, L1 loss can measure pixel-wise differences between the decoder output and the pseudo GT depth.

At block 412, the video tokenizer system 400 can use and/or otherwise integrate a SAM model (e.g., Segment Anything Model) to generate segmentation masks for object-level reweighting. That is, the SAM model and/or segmentation layers can be used to perform object boundary detection, region identification, and/or mask generation. At block 414, the segmentation masks can be used to refine the outputs of the image and feature decoders. That is, refining the outputs can be performed by the decoder of block 406 by isolating specific regions in the feature map (e.g., objects, lane boundaries, road edges). For example, refining the image decoder output can include adjusting pixel values in detected object regions. In another example, refining the feature decoder output can include improving feature representations for object categories (e.g., vehicles, pedestrians). In some implementations, the segmentation mask can be used for object-specific reweighting by isolating regions (e.g., vehicles, pedestrians). That is, the SAM model can be used by the decoder to guide and/or otherwise apply weight adjustments in the reweighting process. For example, segmentation masks can highlight lane markers and vehicles for improved feature decoding.

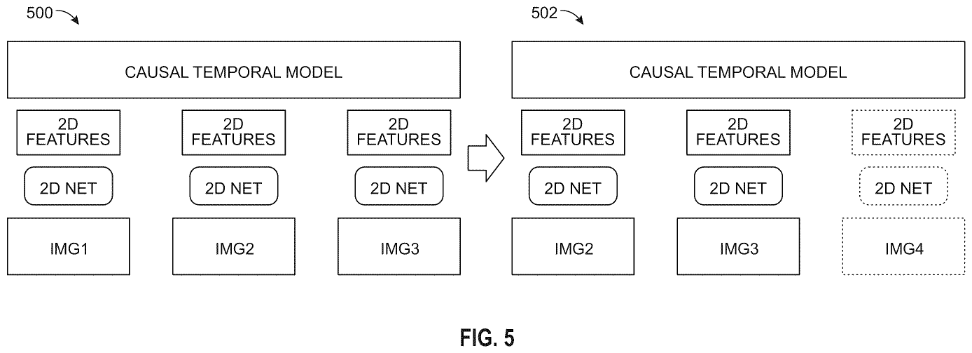

Referring now to FIG. 5, a block diagram of a temporal-based video tokenizer system with a caching mechanism for integrating 2D and 3D features, in accordance with some implementations of the present disclosure. At modeling step block 502, the system 100 can implement a causal temporal model to process 2D features extracted from sequential video frames (e.g., IMG1, IMG2, IMG3). In some implementations, the 2D features can be generated by a 2D image-based network (e.g., ResNet, MobileNet) that extracts spatial characteristics (e.g., edges, textures, object boundaries) from at least one (e.g., each) frame. That is, the 2D network processes at least one (e.g., each) video frame independently (e.g., in parallel, sequentially) to output corresponding 2D feature embeddings. For example, IMG1 can be used to generate feature embeddings that capture road surfaces and object outlines, and IMG2 and IMG3 can be used to generate similar embeddings for their respective frames. In some implementations, the causal temporal model (e.g., based on transformer or recurrent network architectures) processes these 2D features in sequence to capture short-term and long-term dependencies between frames. For example, the causal temporal model can analyze object motion across IMG1, IMG2, and IMG3 to identify trajectory patterns, detect scene changes over time, predict future positions of objects, and/or compute temporal alignment of visual elements. In this example, the system 100 generates video tokens representing both spatial and temporal information, facilitating downstream processing tasks (e.g., motion tracking, scene segmentation).

At modeling step block 502, the system 100 can dynamically integrate new frame features (e.g., IMG4) with cached features from previous frames (e.g., IMG1, IMG2, IMG3, etc.) during inference. In some implementations, the integrating can include reusing previously computed 2D features stored in a cache and combining them with newly generated features from, for example, IMG4. That is, the causal temporal model can be used by system 100 to process the cached features and the features from the current frame to maintain temporal continuity and reduce redundant computations. For example, cached 2D features from IMG3 can provide context for analyzing occluded objects in IMG4. Additionally, the 2D network can process IMG4 to output a corresponding 2D features. The corresponding 2D features can be combined and/or otherwise fused with the cached features in the causal temporal model. For example, the causal temporal model can determine and/or otherwise compute attention scores between IMG4 and previous frames to verify accurate alignment of object positions and motion trajectories.

### EXAMPLE LANGUAGE MODELS

In at least some implementations, language models, such as large language models (LLMs), vision language models (VLMs), multi-modal language models (MMLMs), and/or other types of generative artificial intelligence (AI) can be implemented. Generally, the language models can tokenize input video data, extract features, and/or generate representations to assist in downstream tasks such as trajectory planning, obstacle detection, and/or semantic segmentation. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents —e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc. —as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 6A is a block diagram of an example generative language model system 600 suitable for use in implementing at least some implementations of the present disclosure. Generally, the example generative language model system 600 can include components configured to encode video data, apply auxiliary losses, and generate quantized tokens for processing in resource-constrained environments. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which can include an LLM, a VLM, a multi-modal LM, etc.).

At a high level, the input processor 605 can receive an input 601 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 630 (e.g., LLM/VLM/MMLM/etc.). In some implementations, the input 601 includes plain text in the form of one or more sentences, paragraphs, and/or documents. Additionally or alternatively, the input 601 can include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 can combine text (or can omit text) with image data, audio data, video data, design data, USD data, and/or other types of input data, such as but not limited to those described herein. Taking raw input text as an example, the input processor 605 can prepare raw input text in various ways. For example, the input processor 605 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 can remove stopwords to reduce noise and focus the generative LM 630 on more meaningful content. The input processor 605 can apply text normalization, for example, by converting all characters to lowercase, removing accents, and/or or handling special cases like contractions or abbreviations to ensure consistency. These are just a few examples, and other types of input processing can be applied.

In some implementations, a RAG component 692 (which can include one or more RAG models, and/or can be performed using the generative LM 630 itself) can be used to retrieve additional information to be used as part of the input 601 or prompt. RAG can be used to enhance the input to the LLM/VLM/MMLM/etc. with external knowledge, so that answers to specific questions or queries or requests are more relevant—such as in a case where specific knowledge is required. The RAG component 692 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 601 can be generated using the query or input to the model (e.g., a question, a request, etc.) in addition to data retrieved using the RAG component 692. In some implementations, the input processor 605 can analyze the input 601 and communicate with the RAG component 692 (or the RAG component 692 can be part of the input processor 605, in implementations) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 can retrieve a prior stored conversation history—or at least a summary thereof—and include the prior conversation history along with the current ask/request as part of the input 601 to the generative LM 630.

The RAG component 692 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 692 and the embeddings of the chunks along with the embeddings of the query can be compared to identify the most similar/related embeddings to the query, which can be supplied to the generative LM 630 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc. —graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 692 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 610 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy can depend on factors such as the language being processed, the task at hand, and/or characteristics of the training dataset. As such, the tokenizer 610 can convert the (e.g., processed) text into a structured format according to tokenization schema being implemented in the particular implementation.

The embedding component 620 can use any known embedding technique to transform discrete tokens into (e.g., dense, continuous vector) representations of semantic meaning. For example, the embedding component 620 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 605 can resize the data to a standard size compatible with format of a corresponding input channel and/or can normalize pixel values to a common range (e.g., 0 to 1) to ensure a consistent representation, and the embedding component 620 can encode the image data using any known technique (e.g., using one or more convolutional neural networks (CNNs) to extract visual features). In some implementations in which the input 601 includes audio data, the input processor 605 can resample an audio file to a consistent sampling rate for uniform processing, and the embedding component 620 can use any known technique to extract and encode audio features—such as in the form of a spectrogram (e.g., a mel-spectrogram). In some implementations in which the input 601 includes video data, the input processor 605 can extract frames or apply resizing to extracted frames, and the embedding component 620 can extract features such as optical flow embeddings or video embeddings and/or can encode temporal information or sequences of frames. In some implementations in which the input 601 includes multi-modal data, the embedding component 620 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 can apply an encoded representation of the input 601 to the generative LM 630, and the generative LM 630 can process the encoded representation of the input 601 to generate an output 690, which can include responsive text and/or other types of data.

As described herein, in some implementations, the generative LM 630 can be configured to access or use—or capable of accessing or using—plug-ins/APIs 695 (which can include one or more plug-ins, application programming interfaces (APIs), databases, data stores, repositories, etc.). For example, for certain tasks or operations that the generative LM 630 is not ideally suited for, the model can have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 695 to the plug-in/API 695, the plug-in/API 695 can process the information and return an answer to the generative LM 630, and the generative LM 630 can use the response to generate the output 690. This process can be repeated—e.g., recursively—for any number of iterations and using any number of plug-ins/APIs 695 until an output 690 that addresses each ask/question/request/process/operation/etc. from the input 601 can be generated. As such, the model(s) can not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. Generally, the generative LM 630 can integrate multi-scale hierarchical encoding and decoding operations to process spatial and temporal features in video data (e.g., in real-time autonomous vehicle applications). For example, assume input text such as “Who discovered gravity” is tokenized (e.g., by the tokenizer610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 640 can convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 can generate a first token, and the generation mechanism 655 can apply the generated token as an input during a second pass. The process can repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 can output some decoded (e.g., vector) representation of the input being applied during a particular pass. The classifier 650 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 can select or sample a word or token based on a corresponding predicted probability (e.g., select the word with the highest predicted probability) and append it to the output from a previous pass, generating each word or token sequentially. The generation mechanism 655 can repeat the process, triggering successive decoder inputs and corresponding predictions until selecting or sampling a symbol or token that represents the end of the response, at which point, the generation mechanism 655 can output the generated response.

FIG. 6C is a block diagram of an example implementation in which the generative LM 630 includes a decoder-only transformer architecture. For example, the decoder(s) 660 of FIG. 6C can operate similarly as the decoder(s) 645 of FIG. 6B except each of the decoder(s) 660 of FIG. 6C omits the encoder-decoder self-attention layer (since there is no encoder in this implementation). As such, the decoder(s) 660 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 660. As with the decoder(s) 645 of FIG. 6B, each token (e.g., word) can flow through a separate path in the decoder(s) 660, and the decoder(s) 660, a classifier 665, and a generation mechanism 670 can use auto-regression to sequentially generate one token at a time until predicting a symbol or token that represents the end of the response. The classifier 665 and the generation mechanism 670 can operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### EXAMPLE COMPUTING DEVICE

FIG. 7 is a block diagram of an example computing device(s) 700 suitable for use in implementing some implementations of the present disclosure. Generally, the example computing device(s) 700 can execute tokenization pipelines, manage encoder and decoder operations, and facilitate data preprocessing for video frames captured by vehicle-mounted sensors. Computing device 700 can include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one implementation, the computing device(s) 700 can comprise one or more virtual machines (VMs), and/or any of the components thereof can comprise virtual components (e.g., virtual hardware components). For non-limiting examples, one or more of the GPUs 708 can comprise one or more vGPUs, one or more of the CPUs 706 can comprise one or more vCPUs, and/or one or more of the logic units 720 can comprise one or more virtual logic units. As such, a computing device(s) 700 can include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some implementations, a presentation component 718, such as a display device, can be considered an I/O component 714 (e.g., if the display is a touch screen). As another example, the CPUs 706 and/or GPUs 708 can include memory (e.g., the memory 704 can be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 can represent one or more links or busses, such as an address bus, a data bus, a control bus, or a combination thereof. The interconnect system 702 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 706 can be directly connected to the memory 704. Further, the CPU 706 can be directly connected to the GPU 708. Where there is direct, or point-to-point connection between components, the interconnect system 702 can include a PCIe link to carry out the connection. In these examples, a PCI bus need not be included in the computing device 700.

The memory 704 can include any of a variety of computer-readable media. The computer-readable media can be any available media that can be accessed by the computing device 700. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 704 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 706 can be configured to execute at least some of the computer-readable instructions to control one or more components of the computing device 700 to perform one or more of the methods and/or processes described herein. The CPU(s) 706 can each include one or more cores (e.g., one, two, four, eight, twenty-eight, seventy-two, etc.) that are capable of handling a multitude of software threads simultaneously. The CPU(s) 706 can include any type of processor, and can include different types of processors depending on the type of computing device 700 implemented (e.g., processors with fewer cores for mobile devices and processors with more cores for servers). For example, depending on the type of computing device 700, the processor can be an Advanced RISC Machines (ARM) processor implemented using Reduced Instruction Set Computing (RISC) or an x86 processor implemented using Complex Instruction Set Computing (CISC). The computing device 700 can include one or more CPUs 706 in addition to one or more microprocessors or supplementary co-processors, such as math co-processors.

In addition to or alternatively from the CPU(s) 706, the GPU(s) 708 can be configured to execute at least some of the computer-readable instructions to control one or more components of the computing device 700 to perform one or more of the methods and/or processes described herein. One or more of the GPU(s) 708 can be an integrated GPU (e.g., with one or more of the CPU(s) 706 and/or one or more of the GPU(s) 708 can be a discrete GPU. In implementations, one or more of the GPU(s) 708 can be a coprocessor of one or more of the CPU(s) 706. The GPU(s) 708 can be used by the computing device 700 to render graphics (e.g., 3D graphics) or perform general purpose computations. For example, the GPU(s) 708 can be used for General-Purpose computing on GPUs (GPGPU). The GPU(s) 708 can include hundreds or thousands of cores that are capable of handling hundreds or thousands of software threads simultaneously. The GPU(s) 708 can generate pixel data for output images in response to rendering commands (e.g., rendering commands from the CPU(s) 706 received via a host interface). The GPU(s) 708 can include graphics memory, such as display memory, for storing pixel data or any other suitable data, such as GPGPU data. The display memory can be included as part of the memory 704. The GPU(s) 708 can include two or more GPUs operating in parallel (e.g., via a link). The link can directly connect the GPUs (e.g., using NVLINK) or can connect the GPUs through a switch (e.g., using NVSwitch). When combined together, each GPU 708 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 706 and/or the GPU(s) 708, the logic unit(s) 720 can be configured to execute at least some of the computer-readable instructions to control one or more components of the computing device 700 to perform one or more of the methods and/or processes described herein. In implementations, the CPU(s) 706, the GPU(s) 708, and/or the logic unit(s) 720 can discretely or jointly perform any combination of the methods, processes and/or portions thereof. One or more of the logic units 720 can be part of and/or integrated in one or more of the CPU(s) 706 and/or the GPU(s) 708 and/or one or more of the logic units 720 can be discrete components or otherwise external to the CPU(s) 706 and/or the GPU(s) 708. In implementations, one or more of the logic units 720 can be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 can include one or more receivers, transmitters, and/or transceivers that allow the computing device 700 to communicate with other computing devices via an electronic communication network, included wired and/or wireless communications. The communication interface 710 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 720 and/or communication interface 710 can include one or more data processing units (DPUs) to transmit data received over a network and/or through interconnect system 702 directly to (e.g., a memory of) one or more GPU(s) 708.

The I/O ports 712 can allow the computing device 700 to be logically coupled to other devices including the I/O components 714, the presentation component(s) 718, and/or other components, some of which can be built in to (e.g., integrated in) the computing device 700. Illustrative I/O components 714 include a microphone, mouse, keyboard, joystick, game pad, game controller, satellite dish, scanner, printer, wireless device, etc. The I/O components 714 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 can be include depth cameras, such as stereoscopic camera systems, infrared camera systems, RGB camera systems, touchscreen technology, and combinations of these, for gesture detection and recognition. Additionally, the computing device 700 can include accelerometers or gyroscopes (e.g., as part of an inertia measurement unit (IMU)) that allow detection of motion. In some examples, the output of the accelerometers or gyroscopes can be used by the computing device 700 to render immersive augmented reality or virtual reality.

The power supply 716 can include a hard-wired power supply, a battery power supply, or a combination thereof. The power supply 716 can provide power to the computing device 700 to allow the components of the computing device 700 to operate.

The presentation component(s) 718 can include a display (e.g., a monitor, a touch screen, a television screen, a heads-up-display (HUD), other display types, or a combination thereof), speakers, and/or other presentation components. The presentation component(s) 718 can receive data from other components (e.g., the GPU(s) 708, the CPU(s) 706, DPUs, etc.), and output the data (e.g., as an image, video, sound, etc.).

### EXAMPLE DATA CENTER

FIG. 8 illustrates an example data center 800 that can be used in at least one implementations of the present disclosure. Generally, the example data center 800 can provide computational resources for training and updating the encoder and decoder models. The data center 800 can include a data center infrastructure layer 810, a framework layer 820, a software layer 830, and/or an application layer 840.

As shown in FIG. 8, the data center infrastructure layer 810 can include a resource orchestrator 812, grouped computing resources 814, and node computing resources (“node C.R. s”) 816(1)-816(N), where “N” represents any whole, positive integer. In at least one implementation, node C.R. s 816(1)-816(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R. s from among node C.R. s 816(1)-816(N) can correspond to a server having one or more of the above-mentioned computing resources. In addition, in some implementations, the node C.R. s 816(1)-8161(N) can include one or more virtual components, such as vGPUs, vCPUs, and/or the like, and/or one or more of the node C.R. s 816(1)-816(N) can correspond to a virtual machine (VM).

In at least one implementation, grouped computing resources 814 can include separate groupings of node C.R. s 816 housed within one or more racks (not shown), or many racks housed in data centers at various geographical locations (also not shown). Separate groupings of node C.R. s 816 within grouped computing resources 814 can include grouped compute, network, memory or storage resources that can be configured or allocated to support one or more workloads. In at least one implementation, several node C.R. s 816 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 812 can configure or otherwise control one or more node C.R. s 816(1)-816(N) and/or grouped computing resources 814. In at least one implementation, resource orchestrator 812 can include a software design infrastructure (SDI) management entity for the data center 800. The resource orchestrator 812 can include hardware, software, or some combination thereof.

In at least one implementation, as shown in FIG. 8, framework layer 820 can include a job scheduler 828, a configuration manager 834, a resource manager 836, and/or a distributed file system 838. The framework layer 820 can include a framework to support software 832 of software layer 830 and/or one or more application(s) 842 of application layer 840. The software 832 or application(s) 842 can respectively include web-based service software or applications, such as those provided by Amazon Web Services, Google Cloud and Microsoft Azure. The framework layer 820 can be, but is not limited to, a type of free and open-source software web application framework such as Apache Spark™ (hereinafter “Spark”) that can use distributed file system 838 for large-scale data processing (e.g., “big data”). In at least one implementation, job scheduler 828 can include a Spark driver to facilitate scheduling of workloads supported by various layers of data center 800. The configuration manager 834 can be capable of configuring different layers such as software layer 830 and framework layer 820 including Spark and distributed file system 838 for supporting large-scale data processing. The resource manager 836 can be capable of managing clustered or grouped computing resources mapped to or allocated for support of distributed file system 838 and job scheduler 828. In at least one implementation, clustered or grouped computing resources can include grouped computing resource 814 at data center infrastructure layer 810. The resource manager 836 can coordinate with resource orchestrator 812 to manage these mapped or allocated computing resources.

In at least one implementation, software 832 included in software layer 830 can include software used by at least portions of node C.R. s 816(1)-816(N), grouped computing resources 814, and/or distributed file system 838 of framework layer 820. One or more types of software can include, but are not limited to, Internet web page search software, e-mail virus scan software, database software, and streaming video content software.

In at least one implementation, application(s) 842 included in application layer 840 can include one or more types of applications used by at least portions of node C.R. s 816(1)-816(N), grouped computing resources 814, and/or distributed file system 838 of framework layer 820. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 834, resource manager 836, and resource orchestrator 812 can implement any number and type of self-modifying actions based on any amount and type of data acquired in any technically feasible fashion. Self-modifying actions can relieve a data center operator of data center 800 from making possibly bad configuration decisions and possibly avoiding underutilized and/or poor performing portions of a data center.

The data center 800 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 800. In at least one implementation, trained or deployed machine learning models corresponding to one or more neural networks can be used to infer or predict information using resources described above with respect to the data center 800 by using weight parameters calculated through one or more training techniques, such as but not limited to those described herein.

In at least one implementation, the data center 800 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### EXAMPLE NETWORK ENVIRONMENTS

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 700 of FIG. 7—e.g., each device can include similar components, features, and/or functionality of the computing device(s) 700. In addition, where backend devices (e.g., servers, NAS, etc.) are implemented, the backend devices can be included as part of a data center 800, an example of which is described in more detail herein with respect to FIG. 8.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 700 described herein with respect to FIG. 7. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
provide at least one frame of video data, obtained using sensor data from one or more vehicle sensors, to one or more encoders to generate an encoded representation of the at least one frame; and
decode the encoded representation using a plurality of decoders to generate a plurality of tokens to represent the at least one frame, the plurality of decoders comprising at least an image decoder, a feature decoder, and a depth decoder, wherein one or more parameters of the plurality of decoders and the one or more encoders are updated according to example video data captured by example vehicle sensors.

2. The one or more processors of claim 1, wherein the processing circuitry is to update the one or more parameters of the plurality of decoders according to one or more losses associated with at least one of lane detection, object segmentation, or depth estimation.

3. The one or more processors of claim 1, wherein the example video data includes data from a perspective of one or more vehicles operating on one or more roads.

4. The one or more processors of claim 1, wherein the processing circuitry is to provide the encoded representation of the at least one frame to at least one quantizer to discretize the encoded representation to provide to the plurality of decoders.

5. The one or more processors of claim 1, wherein the processing circuitry is to output a codebook comprising the plurality of tokens.

6. The one or more processors of claim 1, wherein the one or more encoders comprise a plurality of layers to perform multi-scale hierarchical encoding.

7. The one or more processors of claim 1, wherein the processing circuitry is to receive the at least one frame as a stream of a plurality of frames of video data, and to use a two-dimensional network to provide image features from the at least one frame and from one or more past frames to the one or more encoders.

8. The one or more processors of claim 1, wherein the processing circuitry comprises a transformer compressor between the one or more encoders and the plurality of decoders, the transformer compressor to generate target tokens for positional encoding to provide to the plurality of decoders.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

10. A system, comprising:
one or more processors to execute operations comprising:
encode, using one or more encoders, at least one frame of video data obtained using sensor data from one or more vehicle sensors, to generate an encoded representation of the at least one frame; and
decode the encoded representation using a plurality of decoders to generate a plurality of tokens to represent the at least one frame, the plurality of decoders comprising at least an image decoder, a feature decoder, and a depth decoder, wherein one or more parameters of the plurality of decoders and the one or more encoders are updated according to example video data captured by example vehicle sensors.

11. The system of claim 10, wherein the operations comprise at least one operation to update the one or more parameters of the plurality of decoders according to one or more losses associated with at least one of lane detection, object segmentation, or depth estimation.

12. The system of claim 10, wherein the example video data includes data from a perspective of one or more vehicles operating on one or more roads.

13. The system of claim 10, wherein the operations comprise operations to provide the encoded representation of the at least one frame to at least one quantizer to discretize the encoded representation to provide to the plurality of decoders.

14. The system of claim 10, wherein the operations comprise at least one operation to output a codebook comprising the plurality of tokens.

15. The system of claim 10, wherein the one or more encoders comprise a plurality of layers to perform multi-scale hierarchical encoding.

16. The system of claim 10, wherein the operations comprise at least one operation to receive the at least one frame as a stream of a plurality of frames of video data, and at least one operation to use a two-dimensional network to provide image features from the at least one frame and from one or more past frames to the one or more encoders.

17. The system of claim 10, wherein the one or more processors comprise a transformer compressor between the one or more encoders and the plurality of decoders, the transformer compressor to generate target tokens for positional encoding to provide to the plurality of decoders.

18. A method, comprising:
providing, using one or more processors, at least one frame of video data obtained using sensor data from one or more vehicle sensors, to one or more encoders to generate an encoded representation of the at least one frame; and
decoding, using the one or more processors, the encoded representation using a plurality of decoders to generate a plurality of tokens to represent the at least one frame, the plurality of decoders comprising at least an image decoder, a feature decoder, and a depth decoder, wherein one or more parameters of the plurality of decoders and the one or more encoders are updated according to example video data captured by example vehicle sensors.

19. The method of claim 18, wherein the method further comprising updating, by the one or more processors, the one or more parameters of the plurality of decoders according to one or more losses associated with at least one of lane detection, object segmentation, or depth estimation.

20. The method of claim 18, wherein the example video data includes data from a perspective of one or more vehicles operating on one or more roads.
